(19) United States
(12) Patent Application Publication
(10) Pub. No.: US 2009/0260475 A1
(43) Pub. Date: Oct. 22, 2009

(54) Road Bicycle Handlebar

(76) Inventor: Cheng-Hsun CHIANG, Taichung County (TW)

Correspondence Address: Dr. BANGER SHIA, 102 Lindencrest Ct., Sugar Land, TX, 77479-5201, US

(21) Appl. No.: 12/494,266

(22) Filed: Jun. 30, 2009

Related U.S. Application Data
(63) Continuation-in-part of application No. 11/620,611, filed on Jan. 5, 2007.

(51) Int. Cl. B62K 21/26; B62K 21/12

(52) U.S. Cl. 74/551.8

(57) ABSTRACT

A road bicycle handlebar comprises a base, a brake control handle, a gear shift handle, a cushion and three spherical cushions. The cushion covers a holding portion of the base for making the holding more comfortable. The three spherical cushions are respectively assembled on the brake control handle and the gear shift handle to make the riding more comfortable. The brake control handle is defined with a groove for placement of fingers of the hand to allow the hand of the rider to be always maintained in a ready-to-press-the-brake-control-handle state, thus improving the riding safety.

This application is a continuation of part of U.S. patent application Ser. No. 11/620,611, which claims the benefit of the earlier filing date of Jan. 05, 2007. Claim 1 of this application is revised from claim 1 of the U.S. patent application Ser. No. 11/620,611, claim 2 of this application is new, and claim 3 of this application corresponds to claim 2 of the U.S. patent application Ser. No. 11/620,611.

### BACKGROUND OF THE INVENTION

1. Field of the Invention

The present invention relates to a handlebar, and more particularly to a road bicycle handlebar.

2. Description of the Prior Art

Bicycles are generally divided into mountain bicycle (also called cross-country bicycle) and road bicycle (also called roadster or racing bicycle) according to function. Here we are going to discuss about the road bicycle only.

Referring to FIG. 1, a conventional handlebar comprises a brake control handle 12 and a gear shift handle 13 which are pivotally connected to a holding portion 11 of a base 10. During the riding process, the rider has to keep gripping firmly the handle all the time. When the rider holds the handle, the handle bears partial weight of the rider. Moreover the shake causing during the riding process will also be transmitted to the rider. So if the handle cannot effectively reduce the pressure from the rider's weight and absorb the shake caused during the riding process, the rider must feel uncomfortable.

In addition, during the riding process, since the brake control handle 12 is not defined with a concave structure for placement of fingers of the hand 20, the rider must grip the base 10 with the thumb (not shown) and other fingers of the hand 20 and is unable to keep his/her fingers always in a ready-to-press-the-brake-control-handle state, as a result, in case of crisis, the rider probably cannot press the brake control handle 12 to produce an emergency braking as quick as needed, thus increasing the riding danger.

The present invention has arisen to mitigate and/or obviate the afore-described disadvantages.

### SUMMARY OF THE INVENTION

The primary objective of the present invention is to provide a road bicycle handlebar covered with a cushion to make the holding more comfortable.

The second objective of the present invention is to provide a road bicycle handlebar utilizing two spherical cushions respectively mounted on a brake control handle and a gear shift handle to make the riding more comfortable.

The third objective of the present invention is to provide a road bicycle handlebar defined with a groove for placement of fingers of the hand to allow the hand of the rider to be always maintained in a ready-to-press-the-brake-control-handle state to improve the riding safety.

Hence, in order to achieve the above objectives, a road bicycle handlebar in accordance with the present invention comprises a brake control handle and a gear shift handle both of which are pivotally coupled to a holding portion of a base and is characterized in that: a cushion is made of plastic material and covers both the holding portion of the base and a pivot portion where the holding portion is pivotally coupled to the brake control handle and the gear shift handle, on a middle portion and a lower end of the brake control handle opposite to the holding portion is respectively assembled a spherical cushion, another spherical cushion is assembled on a far end of the gear shift handle opposite to the holding portion, the three spherical cushions are all made of plastic material, the brake control handle is defined in an outer edge of an upper end thereof with a groove for placement of a forefinger of a hand to allow a thumb and the forefinger of the hand to grip the cushion and the bake control handle.

### BRIEF DESCRIPTION OF THE DRAWINGS

FIG. 1 is a perspective view of a conventional handlebar;

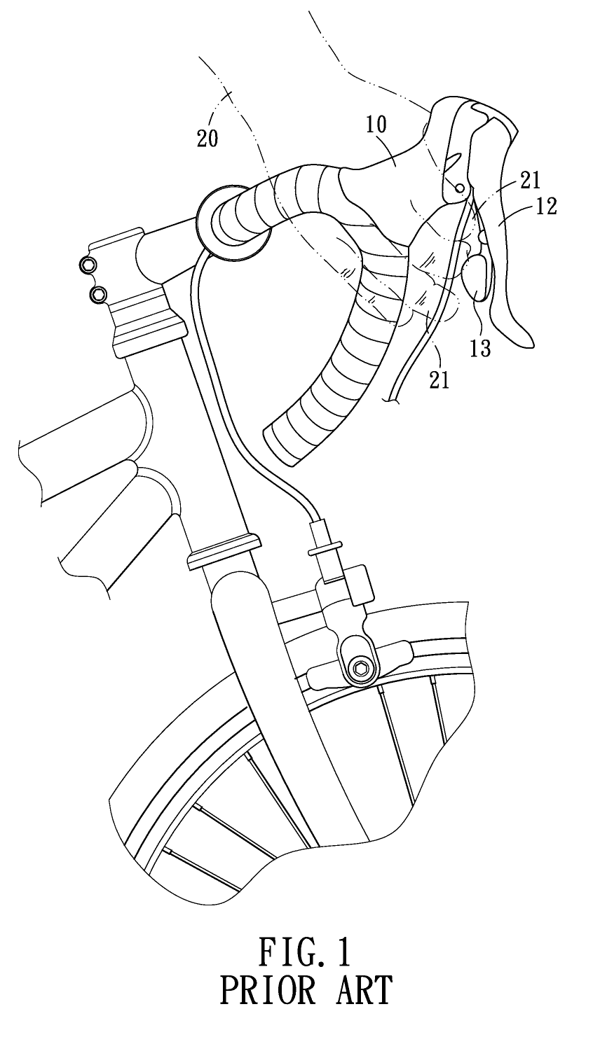

FIG. 2 is a perspective view of a handlebar in accordance with the present invention;

FIG. 3 shows a handlebar in accordance with the prevent invention is being held; and

FIG. 4 is a perspective view of a handlebar in accordance with the preferred embodiment of the present invention in pulling and pressing state.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

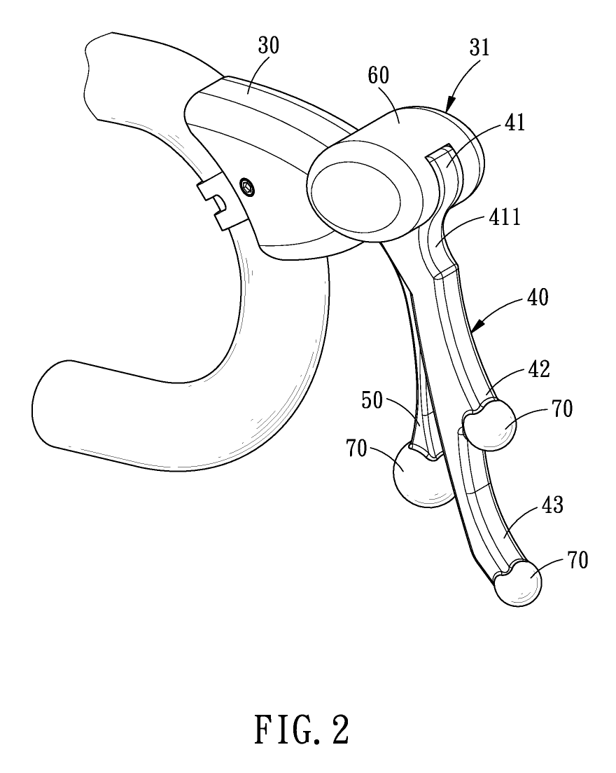

Referring to FIGS. 2-4, a road bicycle handle in accordance with a preferred embodiment of the present invention is shown and comprises a base 30, a brake control handle 40, a gear shift handle 50, a cushion 60 and three spherical cushions 70.

The base 30 has a holding portion 31.

The brake control handle 40 includes an upper end 41, a middle portion 42 and a lower end 43. The upper end 41 is pivotally coupled to the holding portion 31 of the base 30 and defined in an outer edge thereof with a groove 411 for placement of a forefinger 81 of a hand 80. The groove 411 is open toward a running direction of the road bicycle.

The gear shift handle 50 is pivotally coupled to the holding portion 31 of the base 30 and is located adjacent to the brake control handle 40.

The cushion 60 is made of plastic material and thus has elasticity. The cushion 60 covers the holding portion 31 and a pivot portion where the holding portion 31 is pivotally coupled to the brake control handle 40 and the gear shift handle 50. The side surface of the cushion 60 is elliptical-shaped in the present embodiment, and the side surface of the cushion 60 is smaller than the normal palm. By such arrangements, the thumb 82 and the forefinger 81 of the hand 80 can grip the cushion 60 and the brake control handle 40.

The three spherical cushions 70 are made of plastic material and thus has elasticity, two of them are respectively assembled to the middle portion 42 of the brake control handle 40 and the lower end 43 of the brake control handle 40 opposite the holding portion 31, another spherical cushion 70 is assembled on the far end of the gear shift handle 50 opposite to the holding portion 31.

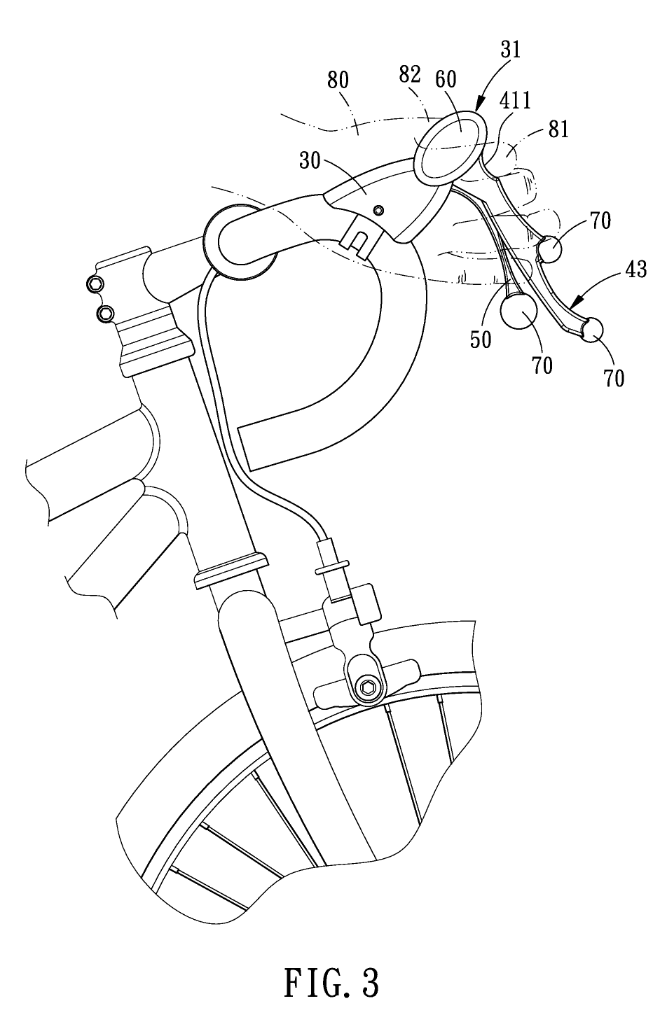

As shown in FIG. 3, when the rider holds the handlebar, the cushion 60 can be provided for gripping to support the body of the rider, since the cushion 60 is made of plastic material and has the elasticity, the counterforce of the weight of the rider acting on the cushion 60 can be absorbed by the cushion 60 and can be reduced, and consequently the force applied to the rider when holding the handle can be reduced. In addition, when riding on the bumpy road, the shake will occur, the cushion 60 and the spherical cushions 70 can also absorb the shake transmitted to the hand 80 of the rider to ease the uncomfortable feeling caused by the shake, therefore, the cushion 60 and the spherical cushions 70 can make rider more comfortable when gripping.

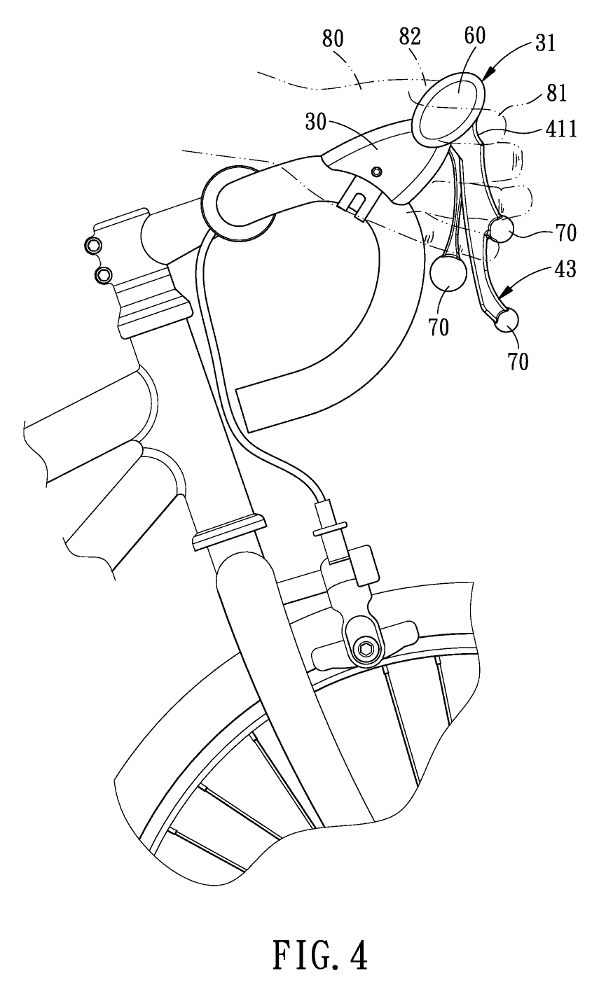

Referring to FIG. 4, the rider can pull the brake control handle 40 and the gear shift handle 50 by pulling the spherical cushions 70 with fingers, since the spherical cushions are made of plastic material and has the elasticity, which improves the feeling of gripping and prevents slippage.

In the present invention, the upper end 41 of the brake control handle 40 is defined in the outer edge thereof with the groove 411, and the groove 411 is open toward the running direction of the road bicycle, so that the thumb 82 and the forefinger 81 of the hand 80 can grip the cushion 60 and the brake control handle 40 during the riding process to allow the hand 80 of the rider to be always maintained in a ready-to-press-the-brake-control-handle state. By such arrangements, in case of crisis, the rider can press the brake control handle 70 to stop the road bicycle as quickly as needed, thus avoiding the occurrence of accident. Hence, the present invention can assuredly improve the riding safety.

While we have shown and described various embodiments in accordance with the present invention, it is clear to those skilled in the art that further embodiments may be made without departing from the scope of the present invention.

What is claimed is:

1. A road bicycle handlebar comprising: a brake control handle and a gear shift handle both of which are pivotally coupled to a holding portion of a base, characterized in that:
a cushion is made of plastic material and covers both the holding portion of the base and a pivot portion where the holding portion is pivotally coupled to the brake control handle and the gear shift handle, on a middle portion and a lower end of the brake control handle opposite to the holding portion is respectively assembled a spherical cushion, another spherical cushion is assembled on a far end of the gear shift handle opposite to the holding portion, the three spherical cushions are all made of plastic material, the brake control handle is defined in an outer edge of an upper end thereof with a groove for placement of a forefinger of a hand to allow a thumb and the forefinger of the hand to grip the cushion and the bake control handle.

2. The road bicycle handlebar as claimed in claim 1, wherein the groove is open toward a running direction of the road bicycle.

3. The road bicycle handlebar as claimed in claim 2, wherein a side surface of the cushion is elliptical-shaped.
